(19) United States
(12) Patent Application Publication
(10) Pub. No.: US 2006/0077818 A1
(43) Pub. Date: Apr. 13, 2006

(54) Optical disc processor

(75) Inventors: Masanori Ujino, Osaka (JP); Yasumasa Igi, Osaka (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/225,017

(22) Filed: Sep. 14, 2005

(30) Foreign Application Priority Data
Sep. 15, 2004 (JP) 2004-267711

(51) Int. Cl. G11B 5/09

(52) U.S. Cl. 369/47.1; 369/53.1

(57) ABSTRACT

A controller in an optical disc processor serves as a visual information recording unit for recording visible information by forming visual information-display pits to be closely aggregated together in a given display pattern, the visual information-display pits having a width larger than that of other pits, wherein the title information is contained in a TOC to be recorded on an optical disc. The visual information-display pits are formed on a recording layer closest to a base layer and different from a recording layer on which to form encoded data pits. This makes it possible to record visible information on the optical disc without requiring a user to separately input data for visual information recording.

### BACKGROUND OF THE INVENTION

1. Field of the Invention

The present invention relates to an optical disc processor that records information by forming, on an optical disc, pits which cause light reflection different from that caused by areas around the pits on the optical disc.

2. Description of the Related Art

It is known to form many pits, having a width larger than that of other pits, on an optical disc to be closely aggregated together in a given pattern so as to produce transitions between light and dark in e.g. figures and characters on the surface of the optical disc, thereby making the information made of the figures and characters visible to the naked eye for display (refer to e.g. Japanese Laid-open Patent Publication Hei 11-213455). This is based on the phenomenon that the intensity of light reflected from the surface of the optical disc with the pits becomes weaker as the pitch width becomes larger.

In an optical disc processor, it is also known to form many pits to be aggregated together in a given pattern so as to record visible information made e.g. of figures and characters on the surface of an optical disc (refer to e.g. Japanese Laid-open Patent Publications 2003-16649 and 2003-51118). In such an optical disc processor, images photographed by a digital camera and characters input from a keyboard are input as data for visual information recording so as to record such images and characters on the surface of the optical disc.

In order to record visible information on the surface of an optical disc in such conventional optical disc processors as described above, it is required to input images photographed by a digital camera and characters input from a keyboard as data for visual information recording. Accordingly, a user has to connect a digital camera or a keyboard to the optical disc processor each time for the user to input the data for visual information recording. This is laborious and inconvenient to use.

### SUMMARY OF THE INVENTION

An object of the present invention is to provide such an optical disc processor that can record visible information on an optical disc without requiring a user to separately input data for visual information recording when coding information such as video and music and recording the coded information on the optical disc.

According to a first aspect of the present invention, this object is achieved by an optical disc processor comprising: an optical disc drive unit for rotating an optical disc having at least one recording layer which has recording tracks concentrically or spirally formed thereon; an optical head for irradiating light onto the recording tracks of the optical disc so as to form, on the recording tracks, pits which cause light reflection different from that caused by areas around the pits on the optical disc, and further for irradiating light onto the recording tracks of the optical disc so as to receive the light reflected therefrom, and thereby detect the pits; an optical head moving unit for moving the optical head above the optical disc; and a controller for controlling the optical head moving unit to move the optical head, and further for controlling the optical disc drive unit to rotate the optical disc, and still further for controlling the optical head to irradiate light, so as to form the pits and thereby record information on the optical disc, and so as to detect the pits and thereby read the information on the optical disc.

Therein, the controller further serves as a visual information recording unit for recording visible information by forming visual information-display pits to be closely aggregated together in a given pattern, the visual information-display pits having a width larger than that of other pits, wherein the visual information recording unit visibly records title information as visible information, the title information being contained in a TOC (Table of Contents) to be recorded on the optical disc.

According to the first aspect of the present invention, title information contained in the TOC recorded on the optical disc is recorded as visible information on the optical disc. This title information is recorded in the TOC of the optical disc when recording information such as video and music on the optical disc. Accordingly, it is not necessary for a user to separately input data for visual information recording by connecting e.g. a digital camera or a keyboard to the optical disc processor, so that it is possible to easily record visible information on the optical disc. Furthermore, since the title information is recorded as visible information, the user can determine recorded content on the optical disc by viewing the title information visibly recorded on the optical disc, and further can discriminate each individual optical disc.

Preferably, the optical disc is a multi-layer type in which the at least one recording layer is multiple recording layers that are stacked on one side of a base layer of the optical disc, wherein the visual information recording unit records the visible information on a recording layer closest to the base layer of the optical disc. Since visual information-display pits are formed on the recording layer, which is closest to the base layer of the optical disc, transitions between light and dark based on the visual information-display pits are clearly displayed on the optical disc, so that visible information can be displayed to be more easily viewable.

According to a second aspect of the present invention, the above object is achieved by an optical disc processor comprising: an optical disc drive unit for rotating an optical disc having recording layers each of which has recording tracks concentrically or spirally formed thereon; an optical head for irradiating light onto the recording tracks of the optical disc so as to form, on the recording tracks, pits which cause light reflection different from that caused by areas around the pits on the optical disc, and further for irradiating light onto the recording tracks of the optical disc so as to receive the light reflected therefrom, and thereby detect the pits; an optical head moving unit for moving the optical head above the optical disc; and a controller for controlling the optical head moving unit to move the optical head, and further for controlling the optical disc drive unit to rotate the optical disc, and still further for controlling the optical head to irradiate light, so as to form the pits and thereby record information on the optical disc, and so as to detect the pits and thereby read the information on the optical disc.

Therein, the controller further serves: as an encoded data recording unit for recording encoded data by forming encoded data pits in an arrangement corresponding to the encoded data produced by encoding information; and as a visual information recording unit for recording visible information by forming visual information-display pits to be closely aggregated together in a given pattern, the visual information-display pits having a width larger than that of other pits, wherein the optical disc is a multi-layer type in which multiple ones of the recording layers are stacked on one side of a base layer of the optical disc, wherein the controller still further serves: as a title information acquisition unit for reading and acquiring title information contained in a TOC (Table of Contents) recorded on the optical disc; and as a coordinate calculating unit for calculating position coordinates on the optical disc on which to form the visual information-display pits so as to visibly record, on the optical disc, the title information acquired by the title information acquisition unit, wherein based on coordinates calculated by the coordinate calculating unit, the visual information recording unit forms the visual information-display pits on a recording layer closest to the base layer of the optical disc so as to visibly record the title information, in which the visual information recording unit forms the visual information-display pits by increasing the spot diameter of collected light emitted from the optical head, and by increasing the intensity of the light emitted from the optical head, and wherein the encoded data recording unit records the encoded data by forming the encoded data pits on a recording layer other than the recording layer closest to the base layer of the optical disc.

According to the second aspect of the present invention, title information contained in the TOC recorded on the optical disc is recorded as visible information on the optical disc. This title information is recorded in the TOC of the optical disc when recording information such as video and music on the optical disc. Accordingly, it is not necessary for a user to separately input data for visual information recording by connecting e.g. a digital camera or a keyboard to the optical disc processor, so that it is possible to easily record visible information on the optical disc. Furthermore, since the title information is recorded as visible information, the user can determine recorded content on the optical disc by viewing the title information visibly recorded on the optical disc, and further can discriminate each individual optical disc. In addition, visual information-display pits are formed on the recording layer, which is closest to the base layer of the optical disc, while encoded data pits are formed on a recording layer other than the closest recording layer. Accordingly, transitions between light and dark based on the visual information-display pits are clearly displayed on the optical disc, so that visible information can be displayed to be more easily viewable.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is a block diagram schematically showing the configuration of an optical disc processor according to an embodiment of the present invention;

FIG. 2A is a schematic plan view showing an optical disc having visible information recorded by the optical disc processor, while FIG. 2B is a schematic partially enlarged view of FIG. 2A;

FIG. 3 is a schematic cross-sectional view of a part of the optical disc showing the optical disc to be used by the optical disc processor;

FIG. 4 is a schematic plan view of a part of the optical disc showing an example of pits formed on the optical disc; and

FIG. 5 is a flow chart showing a recording operation of recording visible information in the optical disc processor.

### DESCRIPTION OF THE PREFERRED EMBODIMENTS

Embodiments of the present invention, as best mode for carrying out the invention, will be described hereinafter. It is to be understood that the embodiments described herein are not intended as limiting, or encompassing the entire scope of, the invention.

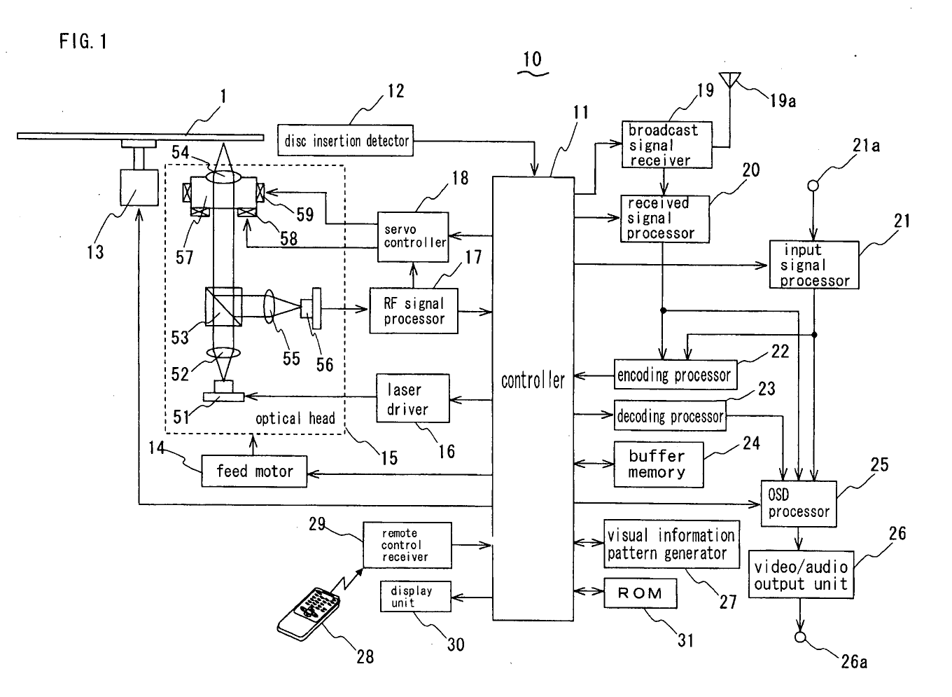

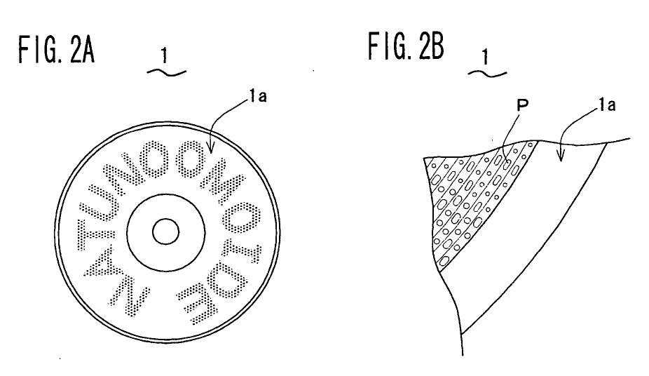

An optical disc processor according to an embodiment of the present invention will be described hereinafter with reference to the drawings. FIG. 1 is a block diagram schematically showing the configuration of an optical disc processor 10. FIG. 2A is a schematic plan view showing an optical disc 1 having visible information recorded by the optical disc processor 10, while FIG. 2B is a schematic partially enlarged view of FIG. 2A. Referring to FIG. 2B, the optical disc 1 is an information recording medium having an information recording surface 1a on which pits P to cause light reflection different from that of areas around the pits are formed so as to record coded information such as video and music. The optical disc processor 10 is a device that forms pits P on the optical disc 1 so as to record coded information on the optical disc 1, and further detects the pits formed on the optical disc 1 so as to reproduce the information recorded on the optical disc 1. Furthermore, the optical disc processor 10 is designed to be operable by a user to record, on the optical disc 1, information which is visible to the naked eye based on variations of reflection intensities caused by the pits P (an example of the information shown in FIG. 2A is “NATUNOOMOIDE”).

The optical disc processor 10 comprises: a controller 11 including a CPU (Central Processor Unit) for controlling the optical disc processor 10. As will be clear from later descriptions, the controller 11, by itself or with other elements, serves: as an encoded data recording unit for recording encoded data by forming encoded data pits in an arrangement corresponding to the encoded data produced by encoding information; as a visual information recording unit for recording visible information by forming visual information-display pits to be closely aggregated together in a given pattern, the visual information-display pits having a width larger than that of other pits; as a title information acquisition unit for reading and acquiring title information contained in a TOC (Table of Contents) recorded on the optical disc 1; as a coordinate calculating unit for calculating position coordinates on the optical disc 1 on which to form the visual information-display pits so as to visibly record, on the optical disc 1, the title information acquired by the title information acquisition unit; and as other units.

The optical disc processor 10 further comprises: a disc insertion detector 12; a spindle motor 13; a feed motor 14; an optical head 15; a laser driver 16; an RF (Radio Frequency) signal processor 17; a servo controller 18; a broadcast signal receiver 19; a received signal processor 20; an input signal processor 21; an encoding processor 22; a decoding processor 23; a buffer memory 24; an OSD (On Screen Display) processor 25; a video/audio output unit 26; a visual information pattern generator 27; a remote control 28; a remote control receiver 29; a display unit 30; and a ROM (Read Only Memory) 31. The disc insertion detector 12 detects that the optical disc 1 has been inserted into a disc insertion slot (not shown), and inputs the detection signal to the controller 11. The optical disc 1 inserted into the disc insertion slot is mounted on the spindle motor 13. The spindle motor 13 is rotated under the control of the controller 11 so as to rotate the mounted optical disc 1. These elements, including the spindle motor 13, for rotating the optical disc 1 constitute an optical disc drive unit. The feed motor 14 comprises a linear motor, and moves the optical head 15 above the optical disc 1 in a radial direction of the optical disc 1. The feed motor 14, with other elements in case of need for moving the optical head 15 above the optical disc 1, constitutes an optical head moving unit.

For recording information of the coded data and the visible information on the optical disc 1, the optical head 15 irradiates light onto the optical disc 1 so as to form pits P to cause light reflection different from that around the pits P. Further, for reading the information of the coded data recorded on the optical disc 1, the optical head 15 irradiates light onto the optical disc 1 so as to detect the pits P formed on the optical disc 1. The optical head 15 comprises a semiconductor laser 51, a collimating lens 52, a beam splitter 53, an objective lens 54, a collecting lens 55 and a light receiving element 56.

The semiconductor laser 51 is driven by the laser driver 16 to emit light. The light emitted from the semiconductor laser 51 is collected and irradiated onto the optical disc 1 through the collimating lens 52, beam splitter 53, and objective lens 54. Light reflected from the optical disc 1 is collected onto the light receiving element 56 through the objective lens 54, beam splitter 53 and collecting lens 55. The objective lens 54 is held by a lens holder 57, and is moved in a direction perpendicular to the surface of the optical disc 1 and in a radial direction of the optical disc 1 by the magnetic force of a focusing coil 58 and a tracking coil 59 under the control of the servo controller 18. The movement of the objective lens 54 is used to adjust the position of the collecting point and the spot diameter of the collected light, which is originally emitted from the semiconductor laser 51 and thereafter collected and irradiated onto the optical disc 1. The light receiving surface of the light receiving element 56 is divided into multiple areas. The multiple areas of the light receiving element 56 respectively output electric signals according to the light intensities received thereby.

The optical head 15 irradiates light emitted from the semiconductor laser 51 onto the information recording surface 1a of the optical disc 1, and thereby change the properties of the recording layer of the optical disc 1, so as to form pits P. Furthermore, the optical head 15 irradiates light emitted from the semiconductor laser 51 onto the information recording surface 1a of the optical disc 1 in order for the light receiving element 56 to receive light reflected from the optical disc 1, so as to detect the pits P formed on the optical disc 1. For detecting the pits P, the intensity of the light emitted from the semiconductor laser 51 is weakened so as to prevent the property change of the recording layer of the optical disc 1.

The laser driver 16 controls emission timing and emission intensity of the semiconductor laser 51 under the control of the controller 1. Based on output signals from the light receiving element 56, the RF signal processor 17 generates and outputs an RF signal (reflection intensity signal), a focusing error signal and a tracking error signal. Based on the focusing error signal and the tracking error signal from the RF signal processor 17, the servo controller 18 drives the focusing coil 58 and the tracking coil 59, and thereby moves the objective lens 54 so as to control the position of the collecting point of the light emitted from the semiconductor laser 51 and irradiated onto the optical disc 1.

Under the control of the controller 11, the receiving frequency of the broadcast signal receiver 19 is tuned to a frequency of a television broadcast signal transmitted from a broadcast station so as to receive the television broadcast signal via an antenna 19a. Under the control of the controller 11, the received signal processor 20 demodulates the television broadcast signal received by the broadcast signal receiver 19 so as to generate video and audio signals. Furthermore, under the control of the controller 11, the input signal processor 21 processes signals input via a signal input terminal 21a from external devices such as a video camera and a digital camera, so as to generate video and audio signals.

Under the control of the controller 11, the encoding processor 22 receives the video and audio signals generated by and output from the received signal processor 20 and the input signal processor 21, and generates encoded data of these video and audio signals that are encoded in a given format. The buffer memory 24 temporarily stores the encoded data to be recorded on the optical disc 1, and also stores encoded data read from the optical disc 1.

For recording the encoded data on the optical disc 1, the optical head 15 forms, under the control of the controller 11, pits P on the optical disc 1 that are encoded data pits representing the encoded data by lengths and arrangement of the pits. On the other hand, for reading the encoded data from the optical disc 1, the optical disc 15 detects the pits P recorded on the optical disc 1, and the RF signal processor 17 outputs RF signals based on the data detected by the optical disc 15. The controller 11 discriminates the lengths and the arrangement of the pits P on the basis of the output RF signals, whereby the encoded data is read from the optical disc 1.

Under the control of the controller 11, the decoding processor 23 decodes the encoded data read from the optical disc 1 so as to generate video and audio signals. The OSD processor 25 superimposes various on-screen display signals on the video signals under the control of the controller 11. The video/audio output unit 26 outputs video and audio signals to a display, a speaker, and so on through a signal output terminal 26a under the control of the controller 11.

The visual information pattern generator 27 generates a display pattern of visible information to be recorded on the optical disc 1. The visible information is recorded on the optical disc 1 in a manner that many visual information-display pits P, which have a width larger than that of other pits P, are formed on the optical disc 1 so as to be closely aggregated together in a given display pattern area. The visual information pattern generator 27 generates the display pattern based on visual information-creating data input from the controller 11. Based on the display pattern generated by the visual information pattern generator 27 and on address data of the optical disc 1, the controller 11 calculates position coordinates on the optical disc 1 on which to form the visual information-display pits.

The remote control 28 is operated by a user to command the optical disc processor 10 for various operations including: selection of a channel to receive; recording/reproduction of information based on encoded data of e.g. video and audio; and recording of visible information. Thus, the remote control 28 has various operation keys (detailed description omitted) to be operated by the user. When the user operates the various operation keys, the remote control 28 sends out coded infrared signals which are made to correspond to the operations.

The remote control receiver 29 receives infrared signals sent out from the remote control 28, and converts the received infrared signals to electric signals, and further outputs, to the controller 11, the signals corresponding to the operations of the remote control 28. The display unit 30 is provided on a front panel of a main body of the optical disc processor 10 so as to display contents of the operations by the remote control 28, operational states of the optical disc processor 10, and so on. The ROM 31 stores operation programs of the controller 1.

The controller 11 determines the contents of the operations by the remote control 28 based on the output signals from the remote control receiver 29, and controls various operations including an operation of receiving television broadcast signals, an operation of recording, on the optical disc 1, video and audio of television programs transmitted with the television broadcast signals, an operation of recording, on the optical disc 1, video and audio input from e.g. a video camera or a digital camera, an operation of reproducing video and audio recorded on the optical disc 1, and an operation of recording visible information on the optical disc 1.

For recording video and audio of a television program on the optical disc 1, the received signal processor 20 generates, under the control of the controller 11, video and audio signals based on the television broadcast signals received by the broadcast signal receiver 19. The controller 11 controls the encoding processor 22 to encode the video and audio signals, and records the encoded data on the optical disc 1. On the other hand, for recording video and audio input from e.g. a video camera or a digital camera on the optical disc 1, the input signal processor 21 generates, under the control of the controller 11, video and audio signals based on signals input from the signal input terminal 21a. The controller 11 controls the encoding processor 22 to encode the video and audio signals, and records the encoded data on the optical disc 1. For recording the encoded data, encoded data pits representing the encoded data by lengths and arrangement of the pits are recorded as pits P on the optical disc 1.

When recording the video and audio on the optical disc 1, a TOC (Table of Contents) including title information indicating the contents of the recorded video and audio is recorded, under the control of the controller 11, in a read-in area of the optical disc 1 in the format of encoded data. In the case of recording video and audio of a television program, the title information is acquired from electronic program information contained in the television broadcast signal. On the other hand, in the case of recording video and audio input from e.g. the video camera or the digital camera, the title information is either acquired from the input signals or automatically added.

For reproducing video and audio recorded on the optical disc 1, pits formed on the optical disc 1 are detected under the control of the controller 11 so as to read encoded data recorded on the optical disc 1. The controller 11 controls the decoding processor 23 to decode the encoded data, and outputs video and audio signals obtained by the decoding from the video/audio output unit 26. For recording visible information on the optical disc 1, many visual information-display pits P, which have a width larger than that of other pits P, are formed on the optical disc 1 so as to be closely aggregated together in a display pattern indicating the title information contained in the TOC recorded (or to be recorded) on the optical disc 1.

The controller 11 calculates position coordinates on the optical disc 1 on which to form the visual information-display pits as follows. Under the control of the controller 11, title information contained in the TOC recorded (or to be recorded) on the optical disc 1 is read, and is used as visual information-creating data by the visual information pattern generator 27 to generate a display pattern indicating visible information (here the display pattern indicates the title information). Based on the display pattern and the address data of the optical disc 1, the controller 11 calculates the position coordinates.

The visual information-display pits are formed in a manner that the objective lens 54 of the optical head 15 is moved to increase the spot diameter of the collected light emitted from the optical head 15, and that the emission output of the semiconductor laser 51 is increased to increase the intensity of the light emitted from the optical head 15. The controller 11 controls the feed motor 14 to move the optical head 15, and further controls the spindle motor 13 to rotate the optical disc 1, and still further controls the optical head 15 to irradiate light so as to form pits P (encoded data pits and/or visual information-display pits) on the optical disc 1, thereby recording the encoded data and/or the visible information, and so as to detect the pits P on the optical disc 1, thereby reading the encoded data.

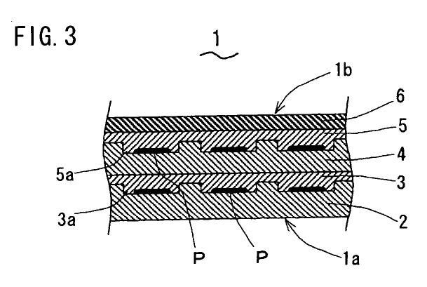

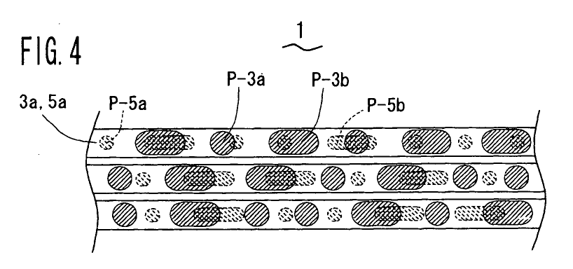

FIG. 3 is a schematic cross-sectional view of a part of the optical disc 1 showing the optical disc 1 to be used by the optical disc processor 10, while FIG. 4 is a schematic plan view of a part of the optical disc 1 showing an example of pits P formed on the optical disc 1. Referring to FIG. 3 and FIG. 4, the optical disc 1 comprises a base layer 2, a first recording layer 3, a spacer layer 4, a second recording layer 5 and a protective layer 6, and is a dual-layer type DVD (Digital Versatile Disc), in which the first recording layer 3 and the second recording layer 5 are stacked on one side of the base layer 2.

The base layer 2 is transparent, and the first recording layer 3 is formed on the base layer 2. The first recording layer 3 is also transparent, and has recording tracks 3a concentrically or spirally formed at a given pitch. The spacer layer 4 is also transparent, and the second recording layer 5 is formed on the spacer layer 4 which in turn is formed on the first recording layer 3. Like the first recording layer 3, the second recording layer 5 has recording tracks 5a concentrically or spirally formed at a given pitch. The protective layer 6 is formed on the second recording layer 5.

A surface of the base layer 2 is an information recording surface 1a. By irradiating light onto the information recording surface 1a (from the side of the base layer 2), pits P are formed on the first recording layer 3 or the second recording layer 5. Also, by irradiating light on the information recording surface 1a, the pits P formed on the first recording layer 3 or the second recording layer 5 are detected. A surface of the protective layer 6 is a label surface 1b. Information indicating e.g. content recorded on the optical disc 1 is described on the label surface 1b by e.g. printing.

The optical disc processor 10 uses such dual-layer type optical disc 1. The optical disc processor 10 assigns the first recording layer 3, closest to the base layer 2, as a recording layer on which to form visual information-display pits, and forms visual information-display pits P-3a and P-3b on the first recording layer 3 (refer to FIG. 4), while it assigns the second recording layer 5, other than the first recording layer 3, as a recording layer on which to form encoded data pits, and forms encoded data pits P-5a and P-5b on the second recording layer 5.

The encoded data pits P-5a and P-5b are formed to have lengths and arrangement corresponding to encoded data produced by encoding information, while the visual information-display pits P-3a and P-3b are formed to have widths larger than those of the encoded data pits P-5a and P-5b and to be closely aggregated together in a given display pattern area (at position coordinates calculated on the basis of the title information contained in the TOC). Since many visual information-display pits P-3a and P-3b having the larger widths are formed to be closely aggregated together in the given pattern area, the light reflection in the display pattern area is reduced so as to produce transitions between light and dark on the information recording surface 1a that correspond to the display pattern. Thereby, e.g. figures and characters (“NATUNOOMOIDE” in the example shown in FIG. 2A) that correspond to a display pattern are displayed as visible information on the information recording surface 1a of the optical disc 1.

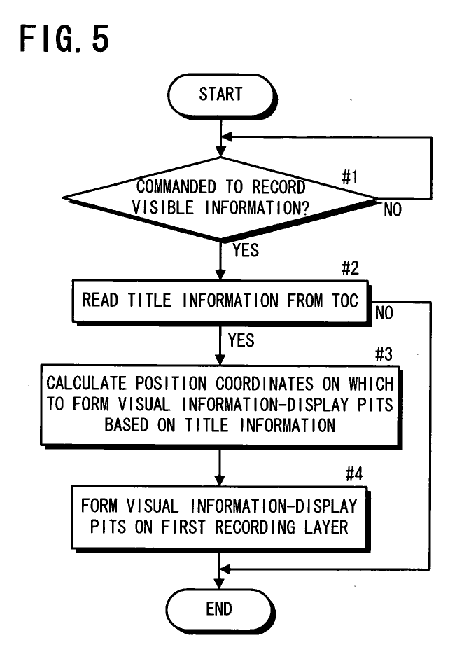

FIG. 5 is a flow chart showing a recording operation of recording visible information in the optical disc processor 10. When commanded by the remote control 28 to record visible information (YES in #1), the controller 11 reads title information contained in the TOC recorded on the optical disc 1 (#2), and calculates position coordinates on the optical disc 1 on which to form visual information-display pits on the basis of the title information (#3). The controller 11 forms visual information-display pits at positions on the first recording layer 3 of the optical disc 1 which correspond to the calculated coordinates (#4). Thereby, visible information is recorded on the optical disc 1. Note that if the controller 11 finds no video or audio recorded on the optical disc 1, and no title information recorded in the TOC in the above step #2, then the controller 11 displays e.g. an error message, and ends the recording operation of recording the visible information.

According to the optical disc processor 10 described above, title information contained in the TOC recorded on the optical disc 1 is recorded as visible information on the optical disc 1. Accordingly, it is not necessary for a user to separately input data for visual information recording by connecting e.g. a digital camera or a keyboard to the optical processor 10. Thus, it is possible to easily record visible information on the optical disc 1 by just operating the remote control 28 to command recording of the visible information. Furthermore, since the title information is recorded as visible information, the user can determine recorded content on the optical disc by viewing the title information visibly recorded on the optical disc 1, and further can discriminate each individual optical disc 1. In addition, according to the optical disc processor 10, visual information-display pits are formed on the first recording layer 3, which is closest to the base layer 2 of the optical disc 1, while encoded data pits are formed on the second recording layer 5 other than the first recording layer 3. Accordingly, transitions between light and dark based on the visual information-display pits are clearly displayed on the optical disc 1, so that visible information can be displayed to be more easily viewable.

It is to be noted that the present invention is not limited to the above-described specific embodiment, and various modifications are possible. For example, the optical disc processor 10 can be designed so that when recording information such as video and music on the optical disc 1, the optical disc processor 10 visibly records title information automatically by forming visual information-display pits on the optical disc 1. More specifically, based on title information to be recorded in the TOC of the optical disc 1 when recording information such as video and music on the optical disc 1, the title information can be visibly recorded on the optical disc 1 before or after the information such as video and music is recorded on the optical disc 1.

According to the above embodiment, visual information-display pits are formed on the first recording layer 3 while encoded data pits are recorded on the second recording layer 5. However, it is possible to form encoded data pits on the first recording layer 3, and visual information-display pits on the second recording layer 5. It is also possible to form both the encoded data pits and the visual information-display pits on either the first recording layer 3 or the second recording layer 5. Although the optical disc 1 according to the above embodiment is a dual-layer type, the optical disc 1 can be other multi-layer type in which multiple recording layers are stacked on one side of the base layer. Furthermore, the optical disc 1 can be a single-layer type. In the case of the single-layer type optical disc, one possible way is to assign a given outermost area of the optical disc 1 as an area for recording visible information and to form visual information-display pits in such area. Another possible way is to allow the visual information-display pits to simultaneously serve as the encoded data pits. In addition, the information to be recorded by using encoded data pits can be information other than video or music.

The present invention has been described above using presently preferred embodiments, but such description should not be interpreted as limiting the present invention. Various modifications will become obvious, evident or apparent to those ordinarily skilled in the art, who have read the description. Accordingly, the appended claims should be interpreted to cover all modifications and alterations which fall within the spirit and scope of the present invention.

What is claimed is:

1. An optical disc processor comprising:
an optical disc drive unit for rotating an optical disc having at least one recording layer which has recording tracks concentrically or spirally formed thereon;
an optical head for irradiating light onto the recording tracks of the optical disc so as to form, on the recording tracks, pits which cause light reflection different from that caused by areas around the pits on the optical disc, and further for irradiating light onto the recording tracks of the optical disc so as to receive the light reflected therefrom, and thereby detect the pits;
an optical head moving unit for moving the optical head above the optical disc; and
a controller for controlling the optical head moving unit to move the optical head, and further for controlling the optical disc drive unit to rotate the optical disc, and still further for controlling the optical head to irradiate light, so as to form the pits and thereby record information on the optical disc, and so as to detect the pits and thereby read the information on the optical disc,
wherein the controller further serves as a visual information recording unit for recording visible information by forming visual information-display pits to be closely aggregated together in a given pattern, the visual information-display pits having a width larger than that of other pits, and
wherein the visual information recording unit visibly records title information as visible information, the title information being contained in a TOC (Table of Contents) to be recorded on the optical disc.

2. The optical disc processor according to claim 1,
wherein the optical disc is a multi-layer type in which the at least one recording layer is multiple recording layers that are stacked on one side of a base layer of the optical disc, and
wherein the visual information recording unit records the visible information on a recording layer closest to the base layer of the optical disc.

3. An optical disc processor comprising:
an optical disc drive unit for rotating an optical disc having recording layers each of which has recording tracks concentrically or spirally formed thereon;
an optical head for irradiating light onto the recording tracks of the optical disc so as to form, on the recording tracks, pits which cause light reflection different from that caused by areas around the pits on the optical disc, and further for irradiating light onto the recording tracks of the optical disc so as to receive the light reflected therefrom, and thereby detect the pits;
an optical head moving unit for moving the optical head above the optical disc; and
a controller for controlling the optical head moving unit to move the optical head, and further for controlling the optical disc drive unit to rotate the optical disc, and still further for controlling the optical head to irradiate light, so as to form the pits and thereby record information on the optical disc, and so as to detect the pits and thereby read the information on the optical disc,
wherein the controller further serves: as an encoded data recording unit for recording encoded data by forming encoded data pits in an arrangement corresponding to the encoded data produced by encoding information; and as a visual information recording unit for recording visible information by forming visual information-display pits to be closely aggregated together in a given pattern, the visual information-display pits having a width larger than that of other pits,
wherein the optical disc is a multi-layer type in which multiple ones of the recording layers are stacked on one side of a base layer of the optical disc,
wherein the controller still further serves: as a title information acquisition unit for reading and acquiring title information contained in a TOC (Table of Contents) recorded on the optical disc; and as a coordinate calculating unit for calculating position coordinates on the optical disc on which to form the visual information-display pits so as to visibly record, on the optical disc, the title information acquired by the title information acquisition unit,
wherein based on coordinates calculated by the coordinate calculating unit, the visual information recording unit forms the visual information-display pits on a recording layer closest to the base layer of the optical disc so as to visibly record the title information, in which the visual information recording unit forms the visual information-display pits by increasing the spot diameter of collected light emitted from the optical head, and by increasing the intensity of the light emitted from the optical head, and
wherein the encoded data recording unit records the encoded data by forming the encoded data pits on a recording layer other than the recording layer closest to the base layer of the optical disc.
